(19) United States
(12) Patent Application Publication
(10) Pub. No.: US 2015/0283762 A1
(43) Pub. Date: Oct. 8, 2015

(54) Three-Dimensional Molding Equipment and Manufacturing Method For Three-Dimensional Shape Plastic Object

(71) Applicant: Matsuura Machinery Corporation, Fukui-City (JP)

(72) Inventors: Toshio Maeda, Fukui-City (JP); Kousuke Ishimoto, Fukui-City (JP); Yasunori Takezawa, Fukui-City (JP); Toshihiko Kato, Fukui-City (JP); Koichi Amaya, Fukui-City (JP)

(21) Appl. No.: 14/556,138

(22) Filed: Nov. 29, 2014

(30) Foreign Application Priority Data
Apr. 4, 2014 (JP) 2014-077413

(51) Int. Cl. B29C 67/00

(52) U.S. Cl. CPC B29C 67/0088; B29C 67/0077; B29K 2105/251

(57) ABSTRACT

Three-dimensional molding equipment includes powder supply equipment which forms powder layer in a laminating process; and a beam scanning unit which radiates a light or electron beam to the powder layer and moves a radiated location of the beam to sinter the powder layer, wherein the laminating and sintering processes alternately repeat, a molding path to be a scanning route of the beam on the inside of an object to be molded is preliminarily set as a continuous route which does not pass a same line and does not form any intersection, and the beam is continuously radiated along the molding path, wherein two molding paths adjacent each other formed of two straight or curve lines are set, and a distance between the adjacent scanning routes is formed larger than a radiation diameter of the beam and not larger than ten-times the radiation diameter of the same.

### BACKGROUND OF THE INVENTION

The present invention relates to three-dimensional molding equipment and a manufacturing method for a three-dimensional shape object, in which the three-dimensional shape plastic object is manufactured by laminating and sintering powder material.

### PRIOR ARTS

According to this kind of invention in prior arts, a three-dimensional shape plastic object including a number of sintered layers is manufactured by repeating a process of supplying powder material from powder supply equipment to form a powder layer and a process of radiating a light beam or an electron beam to a predetermined region of the powder layer formed in the mentioned process to sinter the powder in the predetermined region.

Meanwhile, according to the above prior arts, a galvano scanner device is used to radiate the light beam or electron beam in most cases. For example, Patent Document 1 (JP 2005-336547 A) discloses an invention in which a light beam or an electron beam emitted from a laser oscillator (20) is reflected on a single galvano scanner device (scanner 22), and further radiated to a powder layer by changing the reflecting direction thereof. A scanning route of the light beam or electron beam is called a molding path and preliminarily set and stored in a control circuit. With this configuration, there are effects that a radiated location of the light beam or electron beam can be moved fast by the galvano scanner device and molding time is shortened.

However, according to the prior art, as illustrated in FIG. 7, the galvano scanner device is operated so as to make a scanning route a1 linear and directed from one side to the other side. After that, one side of a light beam or electron beam oscillator is turned OFF and then a radiated location of the galvano scanner device is determined at a predetermined position on the one side (see dotted lines). Subsequently, the laser oscillator is again turned ON and the galvano scanner device is operated such that the scanning route is directed from the one side to the other side and a scanning route a2 becomes substantially parallel to the scanning route a1. Then, sintering is executed so as to hatch a region to be molded E on the powder layer by repeating the above scanning multiple times. Therefore, because of the waiting time for determining the radiated position multiple times, molding time is prolonged.

Additionally, a time difference is brought out between scanning at the beginning and scanning at the end in the above scanning by the light beam or electron beam, and therefore, when the light beam or electron beam is located at the scanning route at the end, for example, temperature in the scanning route may be increased by the light beam or electron beam. However, the temperature at the beginning of the scanning route may be decreased because the scanning route is cooled by ambient air. As a result, due to the above temperature difference, temperature distribution in an entire plastic object may be uneven, and there is possibility in which the shape deformation such as warpage may occur in the plastic object.

### CITATION LIST

### Patent Document

Patent Document 1: JP 2005-336547 A

### SUMMARY OF INVENTION

### Problems to be Solved by the Invention

The present invention is made in view of the above-described exemplary situation, and the object thereof is to improve molding efficiency and avoid occurrence of shape deformation in a plastic object.

To solve the above problems, basic configuration according to the present invention includes:

(1) Three-dimensional molding equipment including: a powder supply equipment which includes a laminating process to form a powder layer; and a light beam or electron beam scanning unit which includes a sintering process to radiate a light beam or an electron beam to the powder layer and move a radiated location of the light beam or the electron beam to sinter the powder layer, wherein the laminating process and the sintering process are configured to alternately repeat, a molding path to be a scanning route of the light beam or electron beam on the inside of an object to be molded is preliminarily set as a continuous route which does not pass a same line and does not form any intersection, and the light beam or electron beam by the light beam or electron beam scanning unit is continuously radiated along the molding path ,and further,

wherein two molding paths adjacent each other formed of two straight lines or two curve lines are set, and further a distance between the adjacent scanning routes is formed larger than a radiation diameter of the light beam or electron beam and larger not more than ten-times of the radiation diameter of the same; and

(2) a manufacturing method for the three-dimensional shape plastic object including: a laminating process to form a powder layer by supplying powder material; and a sintering process to radiate a light beam or an electron beam to the powder layer and move a radiated location of the light beam or the electron beam to sinter the powder layer, wherein the laminating process and the sintering process are configured to alternately repeat, and a molding path to be a scanning route of the light beam or electron beam on the inside of an object to be molded is preliminarily set by a continuous route which does not pass a same line and does not form any intersection, and the light beam or electron beam is continuously radiated along the molding path ,and further,

wherein two molding paths adjacent each other formed of two straight lines or two curve lines are set, and further a distance between the adjacent scanning routes is formed larger than a radiation diameter of the light beam or electron beam and larger not more than ten-times of the radiation diameter of the same.

### Effect of the Invention

According to the present invention based on the above basic configuration, molding efficiency is improved by radiating the light beam or electron beam in the continuous route, and also occurrence of shape deformation is avoided in the plastic object.

Moreover deflection of temperature distribution in a region may be reduced and a highly-qualified three-dimensional shape plastic object may be manufactured.

### BRIEF DESCRIPTION OF DRAWINGS

FIG. 1 is a perspective view illustrating a molding path of example 1, FIG. 1(a) illustrates the situation of progressing gradually inner side, and FIG. 1(b) illustrates the situation of progressing gradually outer side.

FIG. 2 is a plane view illustrating a molding path of example 2.

FIG. 3 is a plane view schematically illustrating an example of three-dimensional molding equipment according to the present invention corresponding to technical premise.

FIG. 4 is a plane view illustrating a molding path in a prior art.

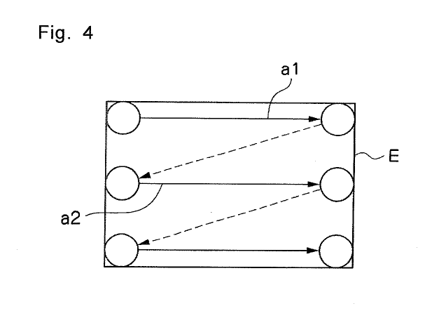

### DETAILED DESCRIPTION

According to the configuration (1) related to the equipment included in the above basic configuration, a powder supply equipment which includes a laminating process to form a powder layer; and a light beam or electron beam scanning unit which includes a sintering process to radiate a light beam or an electron beam to the powder layer and move a radiated location of the light beam or the electron beam to sinter the powder layer, wherein the laminating process and the sintering process are configured to alternately repeat, a molding path to be a scanning route of the light beam or electron beam on the inside of an object to be molded is preliminarily set as a continuous route which does not pass a same line and does not form any intersection, and the light beam or electron beam by the light beam or electron beam scanning unit is continuously radiated along the molding path.

With this configuration, the scanning route of the light beam or electron beam on the inside of the object to be molded is the continuous route which does not pass the same line and the light beam or electron beam is continuously radiated along this route. Therefore, waiting time for position adjustment in the prior art is reduced, thereby achieving to shorten molding time. Further, the same effects can be also achieved in the basic configuration (2) related to the method.

According to the basic configuration (1) and (2), two molding paths adjacent each other formed of two straight lines or two curve lines are set, and further a distance between the adjacent scanning routes is formed larger than a radiation diameter (e.g., about 200 μm) of the light beam or electron beam.

With this configuration, unevenness of the temperature distribution can be reduced by the clearance faulted between the scanning routes adjacent each other, and also occurrence of shape deformation, such as warpage, in the plastic object can be avoided.

Moreover the distance is set larger than the radiation diameter of the light beam or electron beam and larger not more than ten-times of the radiation diameter of the same.

The above-specified range of the distance is a preferable range experimentally-acquired through trial and error by the inventors of the present invention. In the case of setting the distance smaller than the above-specified range, temperature distribution may be uneven because of temperature increase or the like between the scanning routes adjacent in an intersecting direction, and shape deformation, such as warpage, may occur in a plastic object with high possibility. Also, in the case of setting the distance larger than the above-specified range, sintering density between the scanning routes adjacent each other may become small, thereby causing quality deterioration of the plastic object with extremely high possibility.

Technical premise of the basic configurations (1) and (2) should be described in detail based on the drawings as follows:

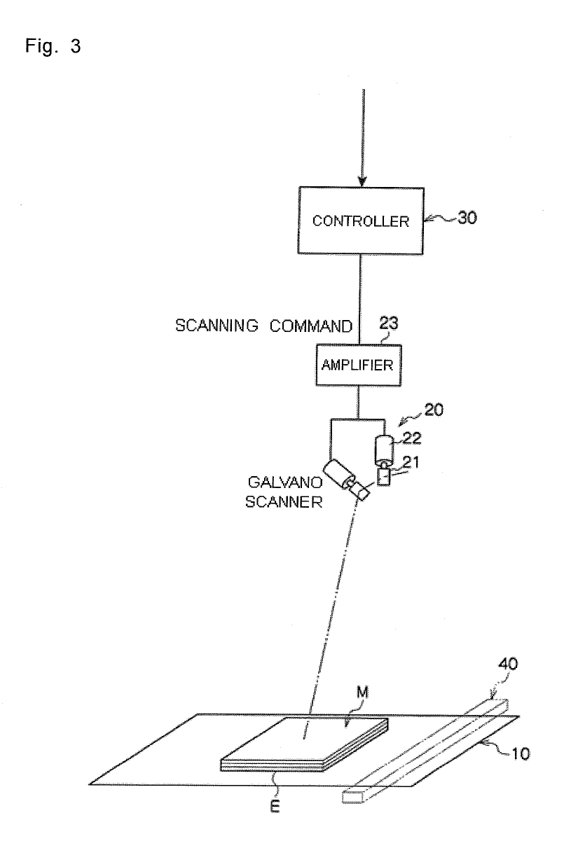

As illustrated in FIG. 3, three-dimensional molding equipment 1 includes: a molding table 10 that can move vertically; a light beam or electron beam scanning unit 20 disposed above the molding table 10; a controller 30 that controls vertical movement of the molding table 10, operation of the respective light beam or electron beam scanning units 20, etc.; and powder supply equipment 40 that supplies powder material on the molding table 10, in which a three-dimensional shape plastic object is manufactured by alternately repeating a laminating process of supplying the powder material to form a powder layer, and a sintering process of radiating a light beam or an electron beam to the powder layer and moving a radiated location thereof to sinter the powder layer.

The molding table 10 is a table having an upper surface formed flat, and configured to move vertically by an elevating mechanism not illustrated.

The molding table 10 moves downward by a predetermined amount every time of repeating the processes of forming the powder layer and partially sintering the powder layer by the later-described powder supply equipment 40 and the light beam or electron beam scanning unit 20.

Meanwhile, as a different example, the molding table 10 may be fixed not movable vertically, and the powder supply equipment 40 may be configured to move vertically.

The light beam or electron beam scanning unit 20 is a two-axis galvano scanner device in which the light beam or the electron beam radiated from a light beam or electron beam oscillator (not illustrated) is reflected by two reflection mirrors 21, 21 and radiated to the upper surface of the powder layer on the molding table 10, and further a radiated location thereof is moved in a planar direction.

Each of the light beam or electron beam scanning unit 20 makes the two reflection mirrors 21, 21 rotate respectively by motors 22, 22 in response to a scanning command from the controller 30. When the mirrors are rotated, scanning is executed by the light beam or the electron beam to be radiated to the upper surface of the powder layer in XY directions by setting, as a origin, a reference position on the molding table 10 imaged by an imaging device (not illustrated) such as a CCD camera.

Note that reference sign 23 in FIG. 3 indicates an amplifier that supplies amplified control voltage of the controller 30 to each of the light beam or electron beam scanning unit 20.

Further, the light beam or electron beam oscillator may be configured to radiate a laser beam emitted from a laser source to the reflection mirror 21 of the light beam or electron beam scanning unit 20.

The controller 30 is a control circuit including a storage unit that stores a processing program, processing data, etc., a CPU, an input/output interface, and so on, and may be formed of a micro-computer, a programmable controller, and other electronic circuits, for example.

The controller 30 receives data input including three-dimensional data (e.g., STL format data, etc.) generated by a CAD/CAM system not illustrated, data related to the radiation diameter of the light beam or electron beam, radiation output of the light beam or electron beam, and so on. Further, the controller 30 executes arithmetic processing based on the processing program which preliminarily stores the above-mentioned data, and controls the light beam or electron beam oscillator (not illustrated), the elevating mechanism (not illustrated) for the molding table 10, the light beam or electron beam scanning unit 20, etc. in accordance with results of the arithmetic processing.

As a means for changing the radiation diameter of the light beam or electron beam, an aperture mechanism capable of changing a beam diameter can be adopted in an optical path of the light beam or electron beam. The aperture mechanism may be provided with a mask plate including a plurality of diaphragm apertures having different diameters, and the plurality of diaphragm apertures may be configured to be selectively moved on the optical path of the light beam or electron beam by moving the mask plate.

Further, the powder supply equipment 40 is a known device that forms a substantially flat powder layer by supplying and squeezing metallic or non-metallic powder material on the flat surface while moving horizontally. The powder supply equipment 40 is configured to move substantially in the horizontal direction above the molding table 10 to form the powder layer on the upper surface of the molding table 10 and laminate additional powder layers over the formed powder layer.

### EXAMPLE

Examples are described as follows.

### Example 1

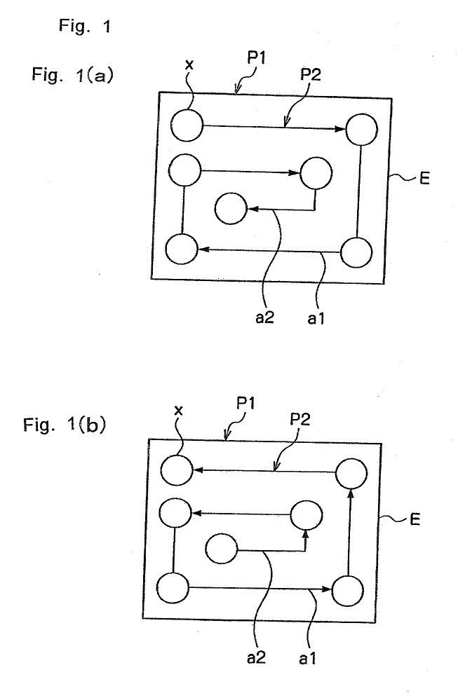

As is illustrated in FIGS. 1(a) and 1(b), according to example 1, the molding path is in an arrangement state in which a plurality of straight lines is connected at a predetermined angle and sequentially directed to the inside or sequentially directed to the outside, or in an arrangement state where a single continuous curve line is sequentially directed to the inside or sequentially directed to the outside.

Explaining concretely the state of achieving the arrangement state more in detail, as illustrated in FIG. 3, the controller 30 actuates the powder supply equipment 40 based on the preliminarily stored processing program, and forms the powder layer on the molding table 10. Subsequently, the controller 30 actuates the light beam or electron beam scanning unit 20 to radiate the light beam or electron beam to the upper surface of the powder layer.

More specifically, the controller 30 sets a region to be molded E on the molding table 10 based on the three-dimensional data and the like as illustrated in FIG. 1(a).

The region to be molded E corresponds to a cross-section of a three-dimensional shape plastic object to be manufactured by the three-dimensional molding equipment 1 taken along a plane parallel to the molding table 10, and the shape of the region to be molded E may be varied by each of the plurality of the powder layers or may be the same in each of the plurality of the powder layers, depending on the shape of the three-dimensional shape plastic object.

Next, as illustrated in FIG. 1(a), the controller 30 radiates the light beam or electron beam to a predetermined position on the region to be molded E on the same powder layer by the light beam or electron beam scanning unit 20, and also controls operation of the light beam or electron beam scanning unit 20 such that a radiated portion x is moved along a preset molding path. The radiated portion x is a temporary region radiated by the light beam or electron beam on the powder layer, and has a radiation diameter adjusted by the aperture mechanism.

The molding path is a scanning route for the light beam or electron beam set based on the three-dimensional data and the like, and stored in a predetermined storage area by the controller 30.

There are two kinds of molding paths: a vector molding path P1 for scanning the region to be molded E along the contour thereof by the light beam or electron beam; and a raster molding path P2 for scanning an inner region of the region to be molded E by the light beam or electron beam so as to hatch the mentioned region. The molding paths are set for the respective powder layers.

The vector molding path P1 is a continuous route formed in an endless ring along the contour of the region to be molded E.

Further, the raster molding path P2 is a continuous route which does not pass a same line and does not form any intersection. According to the example illustrated in FIG. 1(a), the raster molding path is a scanning route having an arrangement state in which a plurality of straight lines is connected at a predetermined angle (right angle in the case of FIG. 1(a)) from the side close to the contour of the region to be molded E, and sequentially directed from the outside to the inside.

Further, the raster molding path P2 is formed spiral so as to hatch an entire region of the region to be molded E. Meanwhile, according to the example illustrated in FIG. 1(a), the raster molding path P2 is formed of a plurality of straight lines parallel to each of the sides of the region to be molded E shaped in a rectangle, but there is another example in which circles or ovals are combined to form a continuous single curve line from the outside to the inside, thereby forming the raster molding path P2 in a spiral curved line gradually directed to the center portion of the region to be molded E.

According to the example in FIG. 1(a), radiation of the light beam or electron beam along the vector molding path P1 and raster molding path P2 is sequentially executed by a single light beam or electron beam scanning unit 20. However, there is another example in which two light beam or electron beam scanning units 20 are provided, and scanning along the vector molding path P1 may be executed by one of the two scanning units, and scanning along the raster molding path P2 may be executed by the other one.

Radiation of the light beam or electron beam is not interrupted in the midway of the route along the vector molding path P1 or the raster molding path P2 and is executed continuously.

When scanning by the light beam or electron beam is executed along the molding paths P1 and P2, the region to be molded E on the upper surface of the powder layer is sintered by heat of the light beam or electron beam. After that, the controller 30 lowers the molding table 10 by the thickness of the powder layer to form a new powder layer on the upper surface of the powder layer including the region to be molded E by means of the powder supply equipment 40.

Then, the controller 30 sets a region to be molded E on the upper surface of the new powder layer in the same manner in the process executed for the above-described first powder layer, and radiate the light beam or electron beam on the region to be molded E by the light beam or electron beam scanning unit 20 and also controls operation of the light beam or electron beam scanning unit 20 so as to move the radiated portion x along the molding paths P1 and P2. As a result, the region to be molded E on the new powder layer is sintered, and further the sintered portion is incorporated to the sintered portion of the previous powder layer.

Afterward, the predetermined three-dimensional shape plastic object M (see FIG. 3) is manufactured by sequentially repeating the processes of lowering the molding table 10, forming the powder layer by the powder supply equipment 40, and sintering the powder layer by executing scanning with the light beam or electron beam of the light beam or electron beam scanning unit 20. Meanwhile, during the above processes, cutting process is applied to an outer peripheral portion of the sintered layer with high accuracy by using a cutting device not illustrated, if necessary.

According to an example illustrated in FIG. 1(b), a scanning direction of a spiral raster molding path P2 is configured in a direction opposite to the example 1. In other words, the raster molding path P2 according to this example is a continuous route which does not pass a same line and does not form any intersection, and a scanning route is formed by connecting a plurality of straight lines at a predetermined angle (right angle in the case of FIG. 1(b)) from a center portion of a region to be molded E and being arranged sequentially directed from the inside to the outside of the region to be molded E.

Therefore, according to the example illustrated in FIG. 1(b), occurrence of waiting time for position adjustment and the like can be reduced and molding time can be shortened same as the example 1. Further, deflection of temperature distribution can be reduced and shape deformation, such as warpage, can be avoided.

Further, according to an example illustrated in FIG. 3, a single light beam or electron beam scanning unit 20 is provided, but there is another example in which a plurality of light beam or electron beam scanning units 20 is provided and a plurality of light beams or electron beams is radiated by these light beam or electron beam scanning units 20 to the region to be molded E for scanning.

### Example 2

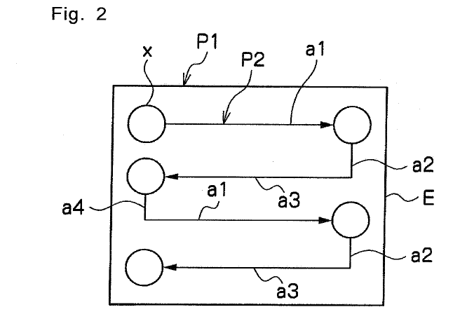

As is illustrated in FIG. 2, according to example 2, the molding path includes a scanning pattern formed of: a first scanning route directed from one side to the other side; a second scanning route continued from the first scanning route and directed in a direction away from the first scanning route at a predetermined angle with respect to the first scanning route; a third scanning route continued from the second scanning route and directed from the other direction to the one direction at a predetermined angle with respect to the second scanning route; and a fourth scanning route continued from the third scanning route and directed in a direction away from the third scanning route at a predetermined angle with respect to the third scanning route, and further this scanning pattern can be repeatedly arranged.

Explaining concretely the situation of forming the molding path more in detail, a raster molding path P2 includes: a scanning pattern formed of a first scanning route a1 directed from one side to the other side; a second scanning route a2 continued from the first scanning route a1 and directed in a direction away from the first scanning route at a predetermined angle (right angle in the case of FIG. 2) with respect to the first scanning route a1; a third scanning route a3 continued from the second scanning route a2 and directed from the other direction to the one direction at a predetermined angle with respect to the second scanning route a2; and a fourth scanning route a4 continued from the third scanning route a3 and directed in a direction away from the third scanning route a3 at a predetermined angle (right angle in the case of FIG. 2) with respect to the third scanning route a3, and this scanning pattern formed in a zigzag shape can be repeated depending on necessity.

Radiation of the light beam or electron beam by a light beam or electron beam oscillator (not illustrated) and a light beam or electron beam scanning unit 20 is continuously executed along the raster molding path P2 without being turned OFF.

In example 1 and 2, a molded path illustrated in FIGS. 1(a), 1(b), and FIG. 2 are set, however a molding path may be also set by suitably combining the molding paths, and the light beam or electron beam radiation can be continuously radiated along this molding path without interruption on the way.

### APPLICABILITY OF THE INVENTION

As is obvious from the above described embodiments and examples, the present invention can industrially exert a great deal of utility value in the fields of three-dimensional molding because the present invention can improve molding efficiency and avoid shape deforming of a plastic object.

### EXPLANATION OF THE REFERENCES

10: Molding table
20: Light beam or electron beam scanning unit
30: Controller
40: Powder supply equipment
E: Region to be molded
P1: Vector molding path
P2: Raster molding path
a1 to a4: Scanning route

1. Three-dimensional molding equipment comprising:
a powder supply equipment which forms a powder layer in a laminating process;
a beam scanning unit which radiates one of a light beam and an electron beam to the powder layer; and
a control unit which controls movement of a radiated location of the beam to sinter the powder layer in a sintering process, such that:
the laminating process and the sintering process are configured to alternately repeat,
a molding path to be a scanning route of the beam on an inside of an object to be molded is preliminarily set as a continuous route which does not pass a same line and does not form any intersection,
the beam by the beam scanning unit is continuously radiated along the molding path,
two molding paths adjacent each other formed of one of two straight lines and two curve lines are set, and
a distance between adjacent scanning routes is formed larger than a radiation diameter of the beam and not larger than ten-times a radiation diameter of the beam.

2. The three-dimensional molding equipment according to claim 1, wherein one said molding path is in one of:
an arrangement state in which a plurality of straight lines are connected at a predetermined angle and one of:
sequentially directed to the inside of the object to be molded and
sequentially directed to an outside of the object to be molded, and
an arrangement state in which a single continuous curve line is one of:
sequentially directed to the inside and
sequentially directed to the outside.

3. The three-dimensional molding equipment according to claim 1, wherein the molding path includes a scanning pattern formed of:
a first scanning route directed from one side to an opposite other side in a first direction,
a second scanning route continued from the first scanning route and directed in a second direction away from the first scanning route at a predetermined angle with respect to the first scanning route,
a third scanning route continued from the second scanning route and directed in a third direction opposite to the first direction and at a predetermined angle with respect to the second direction of the second scanning route, and
a fourth scanning route continued from the third scanning route and directed in a direction away from the third scanning route at a predetermined angle with respect to the third direction of the third scanning route, and
wherein said scanning pattern is adapted to be repeatedly arranged.

4. A method for manufacturing a three-dimensional shape plastic object, comprising the steps of:
a laminating process which forms a powder layer by supplying powder material; and
a sintering process which:
radiates one of a light beam and an electron beam to the powder layer and
moves a radiated location of the beam to sinter the powder layer,
wherein the laminating process and the sintering process are configured to alternately repeat, and
wherein the step of moving includes the steps of:
preliminarily setting a molding path to be a scanning route of the beam on an inside of an object to be molded by a continuous route which does not pass a same line and does not form any intersection,
continuously radiating the beam along the molding path,
forming two molding paths adjacent each other of one of two straight lines and two curve lines, and
forming a distance between the adjacent scanning paths larger than a radiation diameter of the beam and not larger than ten-times a radiation diameter of the beam.
